(19) United States
(12) Patent Application Publication
(10) Pub. No.: US 2018/0230409 A1
(43) Pub. Date: Aug. 16, 2018

(54) Wet Wipes Cleaning And Disinfecting Composition With Reduced Streaking And Residue

(71) Applicant: Rockline Industries, Sheboygan, WI (US)

(72) Inventors: Doulgas B. Cole, Belgium (US); Ryan K. Hood, Sheboygan, WI (US)

(21) Appl. No.: 15/896,509

(22) Filed: Feb. 14, 2018

Related U.S. Application Data
(60) Provisional application No. 62/458,651, filed on Feb. 14, 2017.

(51) Int. Cl. C11D 3/43; C11D 1/66; C11D 3/48; C11D 17/04

(52) U.S. Cl. CPC C11D 3/43; C11D 1/662; C11D 11/0023; C11D 17/049; C11D 3/48

(57) ABSTRACT

A cleaning composition including active ingredients and at least one of a solvent and a surfactant is disclosed. The cleaning composition can be loaded on a cleaning wipe. The solvent and/or surfactant singly or in combination with each other provides an enhancement to the dispersion of the active ingredients within the cleaning composition, depending on the level in the final formulation, thereby reducing streaking and residue of the active ingredients on the surface cleaned with the wipe.

### CROSS-REFERENCE TO RELATED APPLICATIONS

This application claims priority from U.S. Provisional Patent Application Ser. No. 62/458,651, filed on Feb. 14, 2017, the entirety of which is expressly incorporated herein by reference for all purposes.

### FIELD OF THE INVENTION

The present invention relates to a wet wipe and a cleaning and disinfecting composition therefor.

### BACKGROUND OF THE INVENTION

An increasing number of consumers are seeking cleaning products that not only are more natural or sustainable, but which also exhibit better overall efficacy of use. Consumers prefer products that can be readily used around children and pets in convenient forms such as pre-loaded disposable wipes or ready to use sprays, but these more sustainable products still are expected to deliver performance on many attributes, such as cleaning and reduction of germs, at parity to traditional products.

In particular, wet wipes, or hard surface cleaning wipes, have gained wide public acceptance. Cleaning wipes include various types of cleaning and disinfecting compositions, as well as waxes and polish to clean furniture and/or other metal, plastic and/or wood surfaces. Wet wipes can further include soaps and/or detergents to clean countertops, floors, appliances, and/or the like. Short chain alcohols and various other biocides can also be included on cleaning wipes to provide disinfection or to sanitize these and other surfaces.

While effective in providing the desired cleaning of the surfaces, traditional wet wipe cleaning systems used in hard surface cleaning applications continue to present challenges to effectively clean and/or disinfect the surface without leaving behind unsightly streaks or residue. Many ingredients found in hard surface wet wipes that have been used for many years are effective in cleaning and disinfecting the surface, but leave behind streaks and reside when applied to the surface being cleaned, requiring secondary cleaning to remove the streaks and/or residue.

In view of the present state of the art of cleaning compositions for wet wipes, there is a need for an improved cleaning composition for inclusion within a wet wipe cleaning formulation that can be used in a variety of applications related to surface cleaning, antibacterial, disinfecting, sanitizing, and/or surfaces without the deficiencies presented above.

### SUMMARY OF THE INVENTION

In light of the foregoing, in one exemplary embodiment the invention is directed to an effective cleaning system with components providing streak and residue reduction for the wet wipe cleaning composition when applied to a surface. The cleaning composition is a formulation that comprises one or more additives effective in reducing streak formation and increasing the dispersion of the other composition components to reduce residue of the cleaning composition remaining on the surface after application of the composition using the wet wipe.

According to another exemplary embodiment of the invention, the wet wipe cleaning composition includes at least one of a solvent and/or a surfactant that provides a significant improvement of the dispersion of the active ingredients in the cleaning composition, thus effectively reducing the streaking of the composition after application. In one exemplary embodiment, the solvent is a glycol solvent and the surfactant is a nonionic surfactant. In other exemplary embodiments, the surfactant can be an alkyl polyglucoside and/or an alkyl polyglucamide surfactant.

According to another exemplary embodiment of the invention, other components are optionally present in the cleaning composition including the preservative formulation, such as, for example, water, surfactants, emollients, solvents, skin conditioning agents, humectants, fragrances, botanical extracts, oils, silicones and the like, and combinations of the same. All components of the formulation are blended together to form a wet wipe composition, solution or emulsion that can be impregnated within or otherwise applied to a nonwoven, cloth or paper substrate, or combinations of the same to form a usable wet wipe for storage and consumer use.

Other features, benefits and advantages of the present invention will be apparent from this summary and its descriptions of certain embodiments of such formulations and compositions, and will be readily apparent to those skilled in the art having knowledge of the synthetic techniques described therewith. Such features, benefits and advantages will be apparent from the above as taken into conjunction with the accompanying examples, data, and all reasonable inferences to be drawn therefrom.

### DETAILED DESCRIPTION OF CERTAIN EMBODIMENTS

The invention relates to a formulation for a cleaning composition (or simply a “cleaning composition”) comprising at least one of a solvent and/or a surfactant. The cleaning composition of the invention can be used, for example, on wet wipes for cleaning surfaces, such as hard surfaces of wood, metal, and ceramic, among others. As used herein, a “wipe” is a type of article suitable for cleansing or disinfecting or for applying a compound and/or removing materials and compounds from surfaces, such as those disclosed in U.S. Pat. Nos. 7,101,612; 6,814,974; and 6,444,214, each of which is hereby expressly incorporated by reference in its entirety for all purposes. In particular exemplary embodiments, this term refers to an article for cleansing a surface, such as a hard surface, including the removal of waste or other undesired material from the hard surface.

In one exemplary embodiment, the cleaning composition includes a solvent that is compatible with the other components present within the cleaning composition and in the substrate forming the wipe. The solvent, in one exemplary and non-limiting embodiment is a glycol solvent or diol and in certain exemplary embodiments the solvent, which can exclude monohydric alcohols, is selected from C₃-C₁₀ glycols/diols, including a 1,3 diol, such as 2-methyl-1,3-propanediol, which has the following structure:

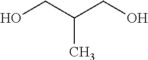

In other exemplary embodiments, the cleaning composition includes a surfactant, with or without the solvent, such as a nonionic surfactant. In one particular exemplary embodiment, the nonionic surfactant is an alkyl polyglycoside or alkyl polyglucoside surfactant, a compound having the following representative structure:

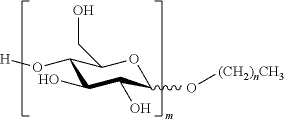

where m is from 1 to 5, and wherein n is from 5 to 17.

In another exemplary embodiment, in which the solvent is an optional component in the cleaning formulation, the surfactant can be an alkyl polyglucamide surfactant where the alkyl component is from C₂-C₂₂, and specifically between C₈-Cis, and more specifically between C₁₂-C₁₄. In one exemplary embodiment, the alkyl polyglucamide surfactant is lauryl n-methyl glucamide and has the following representative structure:

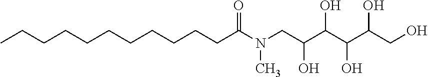 [SMILES: CCCCCCCCCCCC(=O)N(C)CC(O)C(O)C(O)C(O)CO]

It is to be understood that the formulation for the cleaning composition can optionally include various other components or adjuncts. The solvent, surfactant and various other components are blended together to form a wet wipe solution or emulsion that can be applied to a substrate to form a usable wet wipe that enhances the dispersion of the active ingredients or components within the cleaning composition to provide the streak and residue reduction of the composition of the invention.

The amount of solvent, if present, in the final wet wipe solution is from 0.25% to 1.5% by weight, or more particularly between 0.50% to 1.0% by weight of the cleaning solution. As applied to the substrate the solvent is between 0.20% to 1.2% by weight, or more particularly between 0.4% to 0.8% by weight of the finished wet wipe product. The amount of surfactant present in the final wet wipe solution is 0.10% to 1.0% by weight, and more particularly between 0.25% to 0.75% by weight. As applied to the substrate the solvent is between 0.08% to 0.8% by weight, or more particularly between 0.2% to 0.64% by weight of the finished wet wipe product.

In various exemplary embodiments, the solvent and surfactant are used separately or in combination at above mentioned ratios to provide a robust, antimicrobial and preservative formulation or system for use in cleaning composition such as utilized with various substrates to form wet wipes that significantly improves the dispersion of active ingredients within the cleaning composition to significantly improve streak and residue reduction when the wipes including the cleaning composition are utilized to clean a hard surface.

As stated above, the cleaning composition may optionally include and/or be used in combination with one or more additional components or adjuncts. The adjuncts include, but are not limited to, water, surfactants, which can exclude alkoxylated nonionic surfactants and/or mixed ether nonionic surfactants, emollients, fragrances and/or perfumes, botanical extracts, oils and/or lotions, silicones, waxes, dyes and/or colorants, solubilizing materials, stabilizers, thickeners, defoamers, hydrotropes, chelating agents, buffers, builders, enzymes, solvents, bleaching agents, cloud point modifiers, preservatives and/or combinations of the same. Any suitable additional solvent can be utilized with the preservative formulation and cleaning composition including the preservative formulation of the invention.

In one exemplary embodiment of the present invention, the cleaning composition can be loaded onto an absorbent substrate. The absorbent substrate is preferably water-insoluble. By “water-insoluble” is meant that the substrate does not dissolve but may readily break apart upon immersion in water. This cleaning composition can be used on flushable wipes in which the nonwoven substrate readily breaks apart after flushing. The water-insoluble substrate is the implement or vehicle for delivering the cleaning composition of the present invention to the surface being cleaned and disinfected or sanitized. As used herein, the terms “substrate” or “wipe” are intended to include any material on which a cleaning composition may be loaded. In functional applications, a substrate is used to clean an article or a surface, as by wiping. Substrates comprise woven or nonwoven materials, typically made from a plurality of fibers. The substrate can be used by itself (typically by hand) or attached to a cleaning implement, such as a floor mop, handle, or a handheld cleaning tool, such as a toilet cleaning device. A wide variety of materials can be used as the substrate. Nonlimiting examples of suitable water insoluble substrates include nonwoven substrates, woven substrates, sponges, cloths, meshes, paper towels, napkins, cleaning pads, and the like.

Some exemplary embodiments employ nonwoven substrates since they are economical and readily available in a variety of materials. By nonwoven is meant that the layer is comprised of fibers which are not woven into a fabric but rather are formed into a membrane, sheet, substrate, mat, absorbent core or pad layer or combinations thereof. Nonwoven substrates may be comprised of a variety of materials both natural and synthetic. By natural is meant that the materials are derived from plants, animals, insects or byproducts of plants, animals, and insects. By synthetic is meant that the materials are obtained primarily from various man-made materials or from natural materials which have been further altered. The conventional base starting material is usually a fibrous web comprising any of the common synthetic or natural textile-length fibers, or mixtures thereof. Non-limiting examples of natural materials useful in the present invention are silk fibers, keratin fibers and cellulosic fibers. Non-limiting examples of keratin fibers include those selected from the group consisting of wool fibers, camel hair fibers, and the like. Non-limiting examples of cellulosic fibers include those selected from the group consisting of wood pulp fibers, cotton fibers, hemp fibers, jute fibers, flax fibers, and mixtures thereof. Non-limiting examples of synthetic materials useful in the present invention include those selected from the group consisting of acetate fibers, acrylic fibers, cellulose ester fibers, modacrylic fibers, polyamide fibers, polyester fibers, polyolefin fibers, polyvinyl alcohol fibers, rayon fibers, polyurethane foam, and mixtures thereof. Examples of some of these synthetic materials include acrylics such as acrilan, creslan, and the acrylonitrile-based fiber, orlon; cellulose ester fibers such as cellulose acetate, arnel, and acele; polyamides such as nylons; polyesters such as fortrel, kodel, and the polyethylene terephthalate fiber, dacron; polyolefins such as polypropylene, polyethylene; polyvinyl acetate fibers; polyurethane foams and mixtures thereof. In one particular example, the substrate is a 40 gsm spinlace material from PGI or a 45 gsm hydratexture material from Suominen. In certain exemplary embodiments, the substrate can be selected to have a particular composition and/or to include a component, coating or other addition to the substrate composition to enhance the effectiveness of the cleaning composition on the wipe. This can include an enhancement of the streak and residue reduction provided by the cleaning composition or other enhancement and/or an enhancement to the antimicrobial effectiveness of the cleaning composition.

### Example 1

The following are the components and amounts of the same that represent a specific working example/exemplary embodiment of the composition provided herein (percentages are by weight in finished product).
1) octyl decyl dimethyl ammonium chloride: 0.0909%;
2) dioctyl dimethyl ammonium chloride: 0.0364%;
3) didecyl dimethyl ammonium chloride: 0.0545%;
4) alkyl (C₁₄, 50%, C₁₂ 40%, C₁₆ 10%) dimethyl benzyl ammonium chloride: 0.1212%;
5) solvent: 0.750%
6) surfactant: 0.560% Other optional ingredients (chelant, (tetrasodium ethylenediamenetetracacetate); builder, (disodium metasilicate); other surfactants, (non-ionic, anionic, cationic), ethanol, fragrance, water, substrate): 98.387%;

### Example 2

Table 1 represents a specific example of a composition according to the invention that can be loaded onto a cleaning wipe.

| | | % active/ | % in final |
|---|---|---|---|
| Ingredient | % use level | purity | Product (on wipe) |
| Water | 98.1097 | 100 | 78.4880 |
| Solvent | 0.7500 | 100 | 0.6000 |
| Surfactant | 0.5600 | 100 | 0.4480 |
| Active ingredients | 0.3790 | 100 | 0.3030 |
| Chelant | — | 100 | — |
| Disodium metasilicate | — | 100 | — |
| Other surfactants | 0.0013 | 100 | 0.0001 |
| Ethanol | 0.0500 | 100 | 0.0400 |
| Fragrance | 0.1500 | 100 | 0.1200 |
| Substrate | — | — | 20.0000 |

It is noted that the range of cleaning solution impregnated into the substrate includes from between 100% to 500% of the dry weight of the substrate.

The disclosures of all articles and references, including patents, are incorporated herein by reference. The invention and the manner and process of making and using it are now described in such full, clear, concise and exact terms as to enable any person skilled in the art to which it pertains, to make and use the same. All references cited in this specification are incorporated herein by reference. It is to be understood that the foregoing describes preferred embodiments of the present invention and that modifications may be made therein without departing from the spirit or scope of the present invention.

What is claimed is:

1. A cleaning composition having enhanced dispersion of active ingredients within the cleaning composition to reduce streaking and residue, the cleaning formulation comprising active ingredients and at least one of a solvent and a surfactant.

2. A cleaning composition according to claim 1 wherein the solvent is a glycol solvent.

3. A cleaning composition according to claim 2 wherein the solvent is a 1,3 diol.

4. A cleaning composition according to claim 1 wherein the surfactant is a nonionic surfactant.

5. A cleaning composition according to claim 4 wherein the nonionic surfactant is selected from the group consisting of an alkyl polyglycoside, and alkyl polyglucoside and an alkyl polyglucamide.

6. A cleaning composition according to claim 1 wherein no solvent is present.

7. A cleaning composition according to claim 1 comprising a glycol solvent and a nonionic surfactant.

8. A cleaning composition according to claim 7 comprising a 1,3 diol and a nonionic surfactant is selected from the group consisting of an alkyl polyglycoside, and alkyl polyglucoside and an alkyl polyglucamide.

9. A cleaning wipe comprising a substrate and a cleaning composition loaded onto the substrate, the cleaning composition comprising active ingredients and at least one of a solvent and a surfactant.

10. A cleaning wipe according to claim 9 wherein the solvent is a glycol solvent.

11. A cleaning wipe according to claim 10 wherein the solvent is a 1,3 diol.

12. A cleaning wipe according to claim 9 wherein the surfactant is a nonionic surfactant.

13. A cleaning wipe according to claim 12 wherein the nonionic surfactant is selected from the group consisting of an alkyl polyglycoside, and alkyl polyglucoside and an alkyl polyglucamide.

14. A cleaning composition according to claim 9 wherein no solvent is present.

15. A cleaning wipe according to claim 9 comprising a glycol solvent and a nonionic surfactant.

16. A cleaning wipe according to claim 15 comprising a 1,3 diol and a nonionic surfactant is selected from the group consisting of an alkyl polyglycoside, and alkyl polyglucoside and an alkyl polyglucamide.

17. A method of cleaning a surface, the method comprising the steps of:
a) providing a cleaning composition comprising active ingredients and at least one of a glycol solvent and a nonionic surfactant; and
b) applying the cleaning composition to surface.

18. The method of claim 17 wherein the nonionic surfactant is selected from the group consisting of an alkyl polyglycoside, and alkyl polyglucoside and an alkyl polyglucamide.
